(19) United States
(12) Patent Application Publication
(10) Pub. No.: US 2024/0372462 A1
(43) Pub. Date: Nov. 7, 2024

(54) PSRR IMPROVEMENT FOR DC-DC CONVERTERS

(71) Applicant: Texas Instruments Incorporated, Dallas, TX (US)

(72) Inventors: Kevin Scoones, San Jose, CA (US); Orlando Lazaro, Cary, NC (US); Ntiamoah Kwarteng, Dallas, TX (US)

(21) Appl. No.: 18/617,020

(22) Filed: Mar. 26, 2024

Related U.S. Application Data
(60) Provisional application No. 63/464,291, filed on May 5, 2023.

(51) Int. Cl. H02M 1/14; H02M 3/155

(52) U.S. Cl. CPC H02M 1/14; H02M 3/155

(57) ABSTRACT

Control circuits for DC-DC power converters. In one example, a control circuit includes a voltage control loop configured to produce a control voltage based on an output voltage of a DC-DC converter and a reference voltage, and a current control loop configured to produce a control current based on the control voltage. The current control loop may be further configured to adjust the control current based on a signal proportional to an input voltage of the DC-DC converter to provide an adjusted control current that is inversely proportional to the input voltage, and to produce, based on the adjusted control current and an inductor current in an inductor of the DC-DC converter, a drive signal to drive one or more power transistors of the DC-DC converter.

### CROSS REFERENCE TO RELATED APPLICATION

This application claims the benefit of and priority to U.S. Provisional Application No. 63/464,291 filed on May 5, 2023, which is hereby incorporated by reference in its entirety.

### TECHNICAL FIELD

This description relates to DC-DC converters, and more particularly, to circuits and techniques for improving power supply rejection ratio (PSRR) in DC-DC converters.

### BACKGROUND

Many electronic applications utilize power management technology to ensure that the power delivered to the application circuitry meets certain specifications. DC-DC converters are used in a number of power management systems and devices to provide a regulated output voltage. In some instances, ripple or other noise in the input voltage to the DC-DC converter translates into undesirable variations in the output voltage, which can disrupt operation of downstream circuitry. The term power supply rejection ratio (PSRR) is used to describe the capability of an electronic circuit, such as a DC-DC converter, to suppress or filter power supply variations (variations in the input voltage) from appearing in the output signal. In some instances, boost or buck-boost converters may have particularly poor PSRR. While there are various techniques for improving PSRR in buck converters, a number of non-trivial issues remain with respect to improving PSRR in boost or buck-boost converters.

### SUMMARY

According to one example, a control circuit comprises a voltage control loop configured to produce a control voltage based on an output voltage of a DC-DC converter and a reference voltage, and a current control loop configured to produce a control current based on the control voltage, and to adjust the control current based on a signal proportional to an input voltage of the DC-DC converter to provide an adjusted control current that is inversely proportional to the input voltage, and to produce, based on the adjusted control current and an inductor current in an inductor of the DC-DC converter, a drive signal to drive one or more power transistors of the DC-DC converter.

According to another example, a control circuit for a DC-DC power converter comprises a voltage control loop having a first input terminal, a second input terminal, and an output terminal, a first transconductance amplifier having a first input terminal coupled to the output terminal of the voltage control loop, a second input terminal coupled to a reference voltage terminal, and an output terminal, a second transconductance amplifier having a first and second input terminals and an output terminal, and a current control circuit having a current control input terminal and a current control output terminal, the current control input terminal coupled to the output terminal of the first transconductance amplifier, and the current control output terminal coupled to the output terminal of the second transconductance amplifier. In some examples, the current control circuit comprises a first transistor coupled between a voltage supply terminal and the current control input terminal, a first current source coupled between the voltage supply terminal and a first control terminal of the first transistor, a second transistor coupled between the voltage supply terminal and the current control output terminal, a second current source coupled between the voltage supply terminal and a second control terminal of the second transistor, a third transistor coupled between the first current source and a ground terminal and having a third control terminal coupled to the current control input terminal, and a fourth transistor coupled between the second current source and the ground terminal and having a fourth control terminal coupled to the current control input terminal.

According to another example, a control circuit, comprises a voltage control loop circuit having a first input terminal to receive an output voltage of a DC-DC power converter, a second input terminal to receive a reference voltage, and an output terminal, a first transconductance amplifier circuit having a first voltage terminal coupled to the output terminal of the voltage control loop circuit, a second voltage terminal coupled to a first reference voltage terminal, and a current terminal, a second transconductance amplifier circuit configured to monitor an inductor current in the DC-DC power converter and having an output terminal, and a current control circuit having a first terminal coupled to the current terminal of the first transconductance amplifier circuit and a second terminal coupled to the output terminal of the second transconductance amplifier circuit, wherein the current control circuit is configured to modify a control current produced by the first transconductance amplifier circuit based on a signal proportional to an input voltage of the DC-DC power converter so as to produce a drive signal that modifies the inductor current in response to changes in the input voltage.

### BRIEF DESCRIPTION OF THE DRAWINGS

FIG. 1 is a block diagram of an electronic device, in an example.

FIG. 2A is a diagram of a DC-DC power converter having a boost topology and including control circuitry, in an example.

FIG. 2B is a diagram of a DC-DC power converter having a buck-boost topology and including control circuitry, in an example.

FIG. 3 is a schematic diagram of a control circuitry as may be used in a DC-DC power converter, in an example.

FIG. 4 is a circuit diagram of a current control circuit, in an example.

FIG. 5 is a schematic diagram illustrating a variation of the control circuitry of FIG. 3, in an example.

### DETAILED DESCRIPTION

Techniques are described for current control in DC-DC power converters. The techniques can be used to improve power supply rejection ratio (PSRR) in DC-DC power converters, including boost converters and buck-boost converters. In some examples, an improvement of 10 dB-20 dB in the PSRR may be achieved. The techniques may be applied in a variety of circuits and systems, including battery charging systems, for example. As described in more detail below, the techniques can be used to allow the input voltage to be fed forward to a control loop for the DC-DC converter, without requiring the output voltage to first be perturbed. This allows the control signal current to vary inversely proportional to the input voltage without using the feedback path from the output voltage. As a result, the inductor current can be varied in response to ripple or noise in the input voltage while maintaining constant output power, thereby improving the PSRR.

In an example, a control circuit for a DC-DC power converter includes a voltage control loop configured to produce a control voltage based on an output voltage of a DC-DC converter and a reference voltage. The control circuit may further include a current control loop configured to produce a control current based on the control voltage, and to adjust the control current based on a signal proportional to an input voltage of the DC-DC converter to provide an adjusted control current that is inversely proportional to the input voltage. The current control loop may further be configured to produce, based on the adjusted control current and an inductor current in an inductor of the DC-DC converter, a drive signal to drive one or more power transistors of the DC-DC converter. Using both the drive signal and the adjusted control signal, both the duty cycle of the power transistors and the inductor current can be modulated to compensate for noise or variations in the input voltage. These and other aspects are described in more detail below.

### General Overview

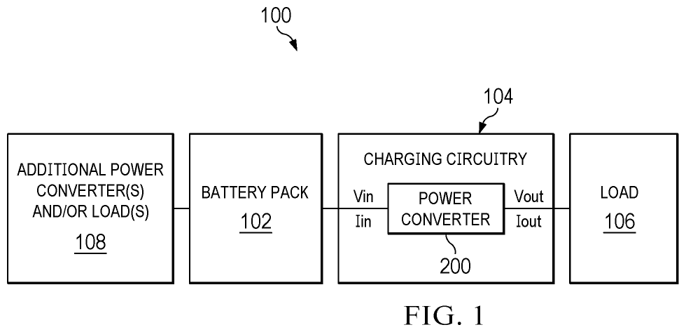

In various power management circuits and systems, a DC-DC power converter can be used to regulate and condition output power supplied to a load. For example, FIG. 1 illustrates an electronic device 100 that includes a battery pack 102, charging circuitry 104, and a load 106. In this example, the charging circuitry 104 includes a power converter 200 that receives an input voltage (Vin) and input current (Iin) from the battery pack 102 and supplies an output voltage (Vout) and output current (Iout) to the load 106. The battery pack 102 may include one or more batteries, such as one or more lithium ion batteries, for example. In some examples, the electronic device 100 can be a relatively complex device, such as a mobile phone or computing device, for example. Accordingly, the battery pack 102 may also provide power to a one or more additional power converter(s) and/or loads 108 (e.g., a step-down power converter to a CPU and/or step-up power converter for backlighting, etc.). In some examples, the various power converters and/or loads all supplied from the battery pack 102 can cause the voltage, Vin, supplied by the battery pack 102 to vary, for example by several hundred millivolts transiently. Without mitigation efforts, these transient variations in the input voltage, Vin, can be transferred through the power converter 200 to the output voltage, Vout, where they can disrupt or prevent correct operation of downstream circuitry in the load 106. Accordingly, it can be highly beneficial to improve the PSRR of the power converter 200 to reduce such transient variations in the output voltage, Vout.

The power converter 200 may be implemented as a buck converter, a boost converter, or a buck-boost converter. In each case, the power converter 200 includes a plurality of power transistors (e.g., field effect transistors) that are coupled to an input voltage terminal that receives the input voltage, Vin, and/or an output voltage terminal at which the output voltage, Vout, is supplied. The arrangement of the power transistors may vary depending on the configuration of the power converter 200, as described further below. In each configuration; however, one or more of the power transistors is also coupled to an inductor that is part of the charging circuitry 104, as also described further below. In the presence of input voltage ripple, a buck converter can be configured to modulate the duty cycle of its power transistors in order to hold the output voltage, Vout, approximately constant (e.g., to avoid perturbations in the output voltage), while the average inductor current also remains approximately constant. Various techniques exist to achieve this result for the buck converter topology. However, for boost converters or buck-boost converters, in the presence of input voltage ripple, these converters should modulate both the duty cycle of the power transistors and the average inductor current in order to maintain a constant output voltage. Therefore, techniques used to improve PSRR in buck converters are not adequate or applicable for boost or buck-boost topologies because they do not address the need to vary the inductor current.

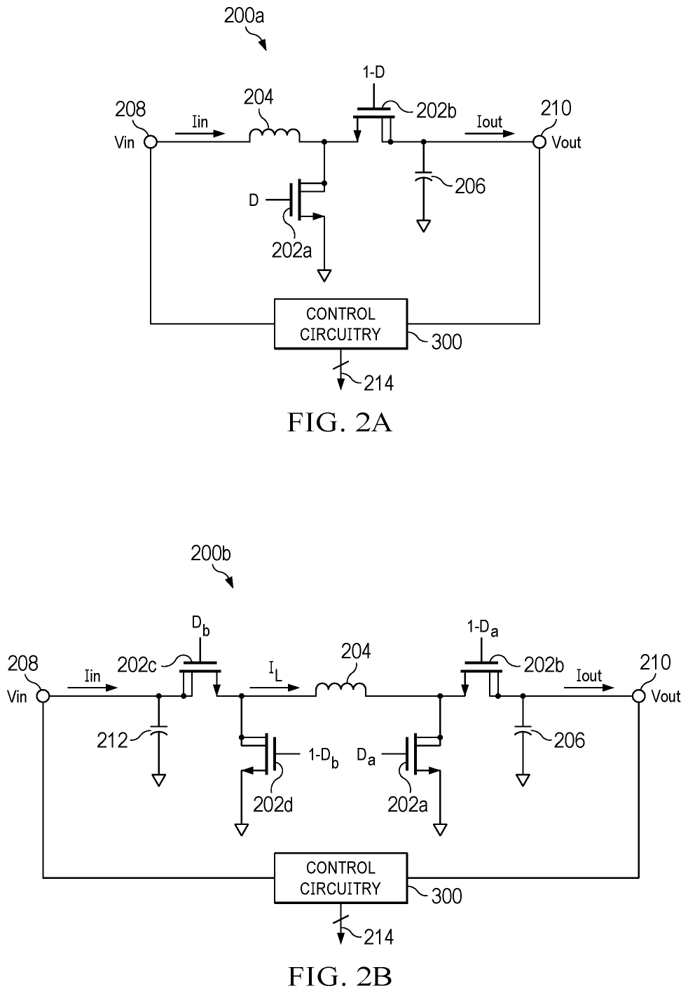

Accordingly, techniques are disclosed for controlling operating conditions in boost or buck-boost power converters that allow for modulation or control of both the power transistor duty cycle and the inductor current. As used herein, the term “inductor current” refers generally to the time-average of the current flowing in the inductor (e.g., inductor 204 shown in FIGS. 2A, 2B, 3, and 5) over a switching cycle of the power converter. As described in more detail below, examples employ control circuitry configured to feed the input voltage into a control signal that is then used to control the inductor current. By introducing the input voltage, the control signal can be made to vary inversely proportional to the input voltage and thus modulate the inductor current to compensate for ripple in the input voltage. By applying these techniques, the PSRR of power converter can be substantially improved, for example, by 10 dB-20 dB in some instances.

### Example Circuit Architecture

FIGS. 2A and 2B are diagrams illustrating power converters including control circuitry according to certain examples. FIG. 2A illustrates a DC-DC converter 200a having a boost topology, and FIG. 2B illustrates a DC-DC converter 200b having a buck-boost topology. The DC-DC converters 200a, 200b may be used as the power converter 200 in the electronic device 100, for example.

Referring to FIG. 2A, in the boost configuration, the DC-DC converter 200a includes a first power transistor 202a, a second power transistor 202b, an inductor 204, and an output capacitor 206. The inductor 204 and the second power transistor 202b are coupled in series between an input voltage terminal 208, at which the input voltage, Vin, (e.g., from the battery pack 102) is received, and an output voltage terminal 210, at which the output voltage, Vout, is supplied. The first power transistor 202a is connected in a shunt configuration from a connection point between the inductor 204 and the second power transistor 202b to ground. The output capacitor 206 is connected in a shunt configuration from the output voltage terminal 210 to ground. The first and second power transistors 202a, 202b having control terminals (e.g., gates) that are driven by complementary drive signals, D and 1-D, respectively.

Referring to FIG. 2B, in the buck-boost configuration, the DC-DC converter 200b further includes third and fourth power transistors 202c, 202d, and an input capacitor 212. The input capacitor 212 is connected in a shunt configuration from the input voltage terminal 208 to ground. The third power transistor 202c is connected between the input voltage terminal 208 and the inductor 204. The fourth power transistor 202d is connected in a shunt configuration from a connection point between the third power transistor 202c and the inductor 204 to ground. In the DC-DC converter 200b, the first and second power transistors 202a, 202b are driven (via their control terminals) by first complementary drive signals, Da and 1-Da, and the third and fourth power transistors 202c, 202d are driven (via their control terminals) by second complementary drive signals, Db and 1-Db.

The DC-DC converters 200a, 200b each include control circuitry 300 that is coupled between the input voltage terminal 208 and the output voltage terminal 210. As described further below, the control circuitry 300 can be configured to generate the drive signals 214 (e.g., D and 1-D in the example of FIG. 2A, or Da, 1-Da, Db, and 1-Db in the example of FIG. 2B) to drive the power transistors 202. In both DC-DC converters 200a, 200b, the output power (Vout*Iout) is directly proportional to the input power (Vin*Iin). Accordingly, in the presence of ripple, or other variations, in the input voltage, Vin, for the output power to remain constant and to avoid perturbing the output voltage, Vout, the input current, Iin, (corresponding generally to the current, I_{L}, flowing through the inductor 204) needs to vary inversely proportional to the input voltage, Vin. Therefore, according to certain examples, the control circuitry 300 is configured to achieve this inversely proportional relationship between the input voltage, Vin, and the inductor current, I_{L}, as described in more detail below.

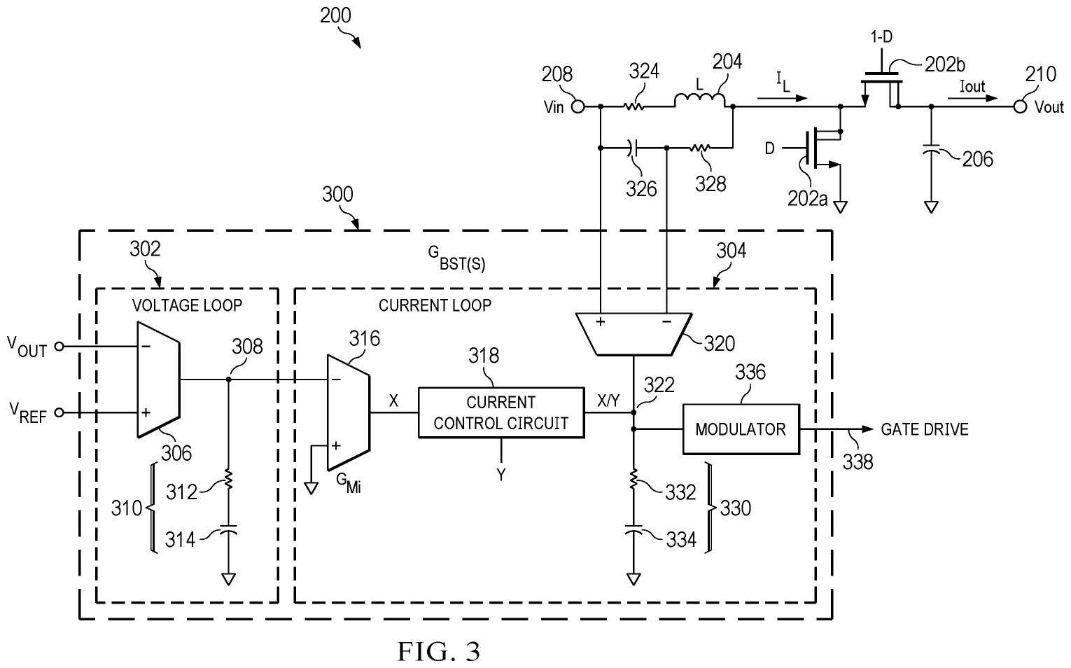

Referring to FIG. 3, there is illustrated an example of the power converter 200 including the control circuitry 300. In this example, the power converter 200 have a boost configuration (e.g., as shown in FIG. 2A); however, as described above, the control circuitry 300 may also be used in power converters having a buck-boost configuration, as shown in FIG. 2B, for example. The control circuitry 300 may be configured to implement average current mode control, wherein a feedback signal is used to generate a value for a “demanded” current and the current through the inductor 204 is regulated to that value of the demanded current.

In some examples, the control circuitry 300 includes a voltage control loop 302 and a current control loop 304. The voltage control loop 302 may include a first transconductance amplifier 306 having a first input terminal to receive the output voltage, Vout, a second input terminal to receive a reference voltage, Vref, and an output terminal 308. The voltage control loop 302 may operate to regulate the output voltage, Vout, to a target value determined by the reference voltage, Vref. In some examples, the voltage control loop 302 is configured to produce a control voltage at the output terminal 308 of the first transconductance amplifier 306, the control voltage being based on the output voltage, Vout, and the reference voltage, Vref. The first transconductance amplifier 306 may have a gain, Gmv. In some examples, the first input terminal of the first transconductance amplifier 306 is coupled to the output voltage terminal 210 to receive the output voltage, Vout. In other examples, the first transconductance amplifier 306 receives a voltage representative of the output voltage, Vout, but not necessarily equal to the output voltage, Vout, (e.g., the voltage may be modified via voltage divider). For simplicity, the following discussion may refer to the voltage control loop 302 receiving the output voltage, Vout; however, it will be appreciated that the operation of the voltage control loop 302 may be the same based on a voltage representative of the output voltage rather than the output voltage itself.

In some examples, the voltage control loop 302 further includes a resistive-capacitive filter 310 coupled in series between the output terminal 308 of the first transconductance amplifier 306 and a reference voltage terminal, such as ground. In the illustrated example, the resistive-capacitive filter includes a resistor 312 and a capacitor 314.

Still referring to FIG. 3, in the illustrated example, the current control loop 304 includes a second transimpedance amplifier 316 and a current control circuit 318. The second transimpedance amplifier has a first input terminal coupled to the output terminal 308 of the first transimpedance amplifier 306 and a second input terminal coupled to a reference voltage terminal, which for simplicity of discussion is considered as AC ground. Thus, the control voltage output from the voltage control loop 302 at the terminal 308 becomes an input voltage for the current control loop 304. The second transimpedance amplifier 316 operates to convert the control voltage at its input terminal to a control current, X, provided at its output terminal. The second transimpedance amplifier may have a gain, Gmi. Accordingly, the control current, X, may be determined by the difference between the voltages at its input terminals, ΔV_{control}, (e.g., the control voltage and the voltage at the reference voltage terminal) multiplied by the gain, Gmi:

$$X = Δ {V}_{control} * {G}_{m i} \qquad ( Eq . 1 )$$

In some examples, the current control loop 304 further includes a third transimpedance amplifier 320 configured to monitor the current flowing through the inductor 204, referred to as the inductor current, I_{L}. In some examples, the third transimpedance amplifier 320 monitors the inductor current using a technique known as DCR sensing. Accordingly, the power converter 200 is shown with its equivalent DC resistance (DCR) 324 coupled in series between the input voltage terminal 208 and a first inductor terminal of the inductor 204, and a series combination of a sense capacitor 326 and a second sense resistor 328 coupled between the input voltage terminal 208 and a second inductor terminal of the inductor 204. The two input terminals of the third transimpedance amplifier 320 may be coupled across the sense capacitor 326, as shown in FIG. 3. The third transimpedance amplifier 320 produces, at its output terminal 322, a current that is representative of the inductor current, I_{L}. In some examples, the third transimpedance amplifier 320 has a gain, Gmsns.

According to certain examples, the current control circuit 318 receives the control current, X, and operates on the control current, X, to produce an adjusted control current, X/Y, also referred to as a demanded current, to which the inductor current, I_{L}, can be regulated. In some examples, the control current, and therefore the demanded current, is scaled down relative to the inductor current by an attenuation factor. In some examples, the adjusted control current, X/Y, is inversely proportional to the input voltage, Vin, as described further below. The current control circuit 318 is coupled to the output terminal 322 of the third transimpedance amplifier 320, as shown in FIG. 3. The output terminal 322 of the third transimpedance amplifier 320 is coupled to the reference voltage terminal (e.g., ground) via a resistive-capacitive filter 330. In the illustrated example, the resistive-capacitive filter 330 includes a resistor 332 coupled in series with a capacitor 334 between the output terminal 322 of the third transimpedance amplifier 320 and the reference voltage terminal.

When the inductor current, I_{L}, is equal to a target value set by the demanded current (e.g., the demanded current scaled up by the attenuation factor), the sum of the currents from the current control circuit 318 and the third transimpedance amplifier 320 are approximately zero, corresponding to a steady-state voltage across the resistive-capacitive filter 330. In some examples, the current control circuit 318 and the third transimpedance amplifier 320 source current, such that a voltage perturbation is produced across the resistive-capacitive filter 330 until the net current is approximately zero. When the inductor current, I_{L}, is equal to the target value set by the demanded current, a steady-state condition exists at the output terminal 322 of the third transimpedance amplifier 320.

In some examples, the current control loop 304 includes a modulator 336 that is also coupled to the output terminal 322 of the third transimpedance amplifier 320. The modulator is configured to produce a gate drive signal 338 based on the signal at the output terminal 322 of the third transimpedance amplifier 320. The gate drive signal 338 produces, or corresponds to, the complementary drive signals, D and 1-D, that are used to drive the power transistors 202a, 202b. In some examples, the gate drive signal 338 is a pulse width modulation (PWM) signal, such as a square-wave signal, for example, with a certain duty cycle between the high (e.g., logic 1) and low (e.g., logic zero) states. The duty cycle of the gate drive signal 338 may vary based on variations in the signal the output terminal 322 of the third transimpedance amplifier 320. Thus, when the inductor current, I_{L}, is equal to the target value set by the demanded current, and a steady-state voltage is present at the output terminal 322, the duty cycle of the gate drive signal 338 may be constant. However, if the inductor current, I_{L}, varies with respect to the demanded current, the voltage at the output terminal 322 may also vary, thus causing the modulator 338 to vary the duty cycle of the gate drive signal 338.

As described above, in some examples, the current control circuit 318 operates on the control current, X, received from the voltage control loop 302 to produce an adjusted control current, or demanded control current value, X/Y, that has an inversely proportional relationship to the input voltage, Vin, present at the input voltage terminal 208. In some examples, to achieve this relationship, the current control circuit divides the control current, X, by a signal, Y, that is based on the input voltage, Vin, and proportional to the input voltage, Vin. Accordingly, as the input voltage, Vin, varies, the demanded current, X/Y, varies in a corresponding, inversely proportional, manner. Thus, the target to which the inductor current, I_{L}, is regulated may be automatically corrected based on changes in the input voltage, Vin, without needing to vary or perturb the output voltage, Vout. Accordingly, the output voltage, Vout, can be maintained constant even in the presence of variations in the input voltage, Vin. The PSRR of the power converter 200 is thus improved.

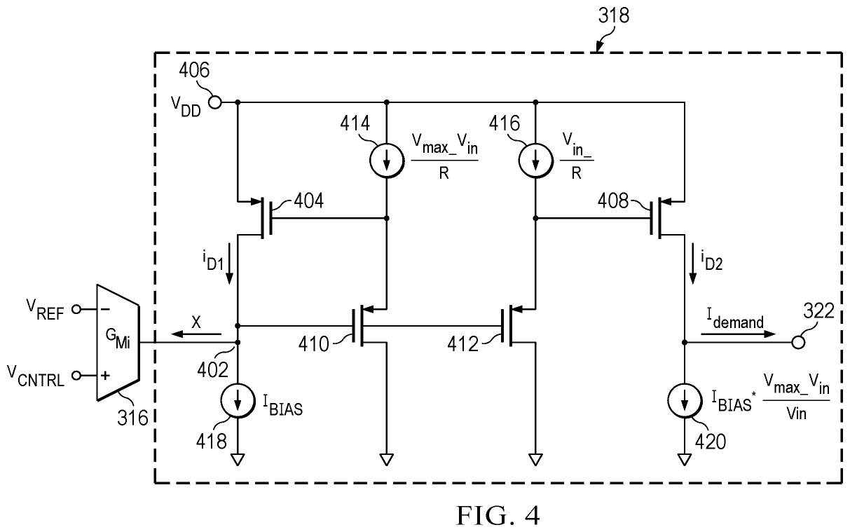

Referring to FIG. 4, there is illustrated a circuit diagram of an implementation of the current control circuit 318 in one example. The current control circuit 318 includes a first terminal 402 coupled to the output terminal of the second transimpedance amplifier 316, as also shown in FIG. 3 and described above. A first transistor 404 is coupled between a supply terminal 406 and the first terminal 402. The current control circuit 318 may receive a DC supply voltage, VDD, at the reference supply terminal 406. In some examples, the current control circuit 318 further includes a second transistor 408 coupled between the supply terminal 406 and the output terminal 322. The current control circuit 318 may further include third and fourth transistors 410, 412, respectively, each having a control terminal (e.g., a gate) coupled to the first terminal 402. The third transistor 410 is coupled between a control terminal of the first transistor 404 and a ground, for example. In some examples, the current control circuit 318 includes a first current source 414 coupled between the supply terminal 406 and the third transistor 410 (and also the control terminal of the first transistor 404), as shown in FIG. 4. A second current source 416 may be coupled between the supply terminal 406 and the fourth transistor 412 (and also the control terminal of the second transistor 408), as also shown in FIG. 4. In some examples, the current control circuit further includes a third current source 418 coupled between the first terminal 402 and ground, and a fourth current source 420 coupled between the output terminal 322 and ground.

As described above, according to certain examples, the current control circuit 318 is configured to introduce the input voltage, Vin, into the current control loop 304 such that the demanded control current, X/Y, can be made to vary inversely proportional to the input voltage, Vin. Accordingly, the second current source 416 can be configured to have a current value equal to the input voltage, Vin, divided by a resistance, R, (Vin/R). Thus, although not shown in FIG. 4, the second current source may be coupled to the input voltage terminal 208 to receive the input voltage, Vin, or a representation thereof. In some examples, the first current source 414 is configured to have a current value equal to a voltage Vmax_Vin divided by the resistance, R, (Vmax_Vin/R). In some examples, the voltage Vmax_Vin is a constant and is set to the maximum expected value of the input voltage, Vin, for example, by using a bandgap voltage.

According to certain examples, the current control circuit 318 is configured to multiply the control current, X, by a factor given by Vmax_Vin/Vin, so as to produce the adjust control current, X/Y, that varies inversely proportional to the input voltage, Vin. In some examples, the four transistors 404, 408, 410, 412, are PMOS devices that are biased in the subthreshold mode. In this condition, a first current, i_{D1}, flows through the first transistor 404 and a second current, i_{D2}, flows through the second transistor 408. The third current source 418 is configured with a current value I_{BIAS}. During operation of the current control circuit 318, the fourth current source 420 sources a current given by I_{BIAS}*Vmax_Vin/R. The currents in the current control circuit 318 can be described by the following set of equations:

$${i}_{D 2} * {V}_{in} / R = {i}_{D 1} * {V}_{max -} {V}_{in} / R \qquad ( Eq . 2 )$$

$${i}_{D 2} = {i}_{D 1} * {V}_{max -} {V}_{in} / {V}_{in} \qquad ( Eq . 3 )$$

$${i}_{demand} + {I}_{BIAS} * {V}_{{maxV}_{in}} / {V}_{in} = ( X + {I}_{BIAS} ) * {V}_{max -} {V}_{in} / {V}_{in} \qquad ( Eq . 4 )$$

$$X / Y = {i}_{demand} = X * {V}_{max -} {V}_{in} / {V}_{in} \qquad ( Eq . 5 )$$

Thus, the current control circuit 318 may produce, at the output terminal 322, the adjusted control current that is inversely proportional to the input voltage, Vin, and to which the inductor current, I_{L}, can be regulated. The current control circuit 318 may thus automatically drive the inductor current, I_{L}, to vary with variations in the input voltage, Vin, without perturbing the output voltage, Vout. As a result, the PSRR of the power converter 200 may be improved.

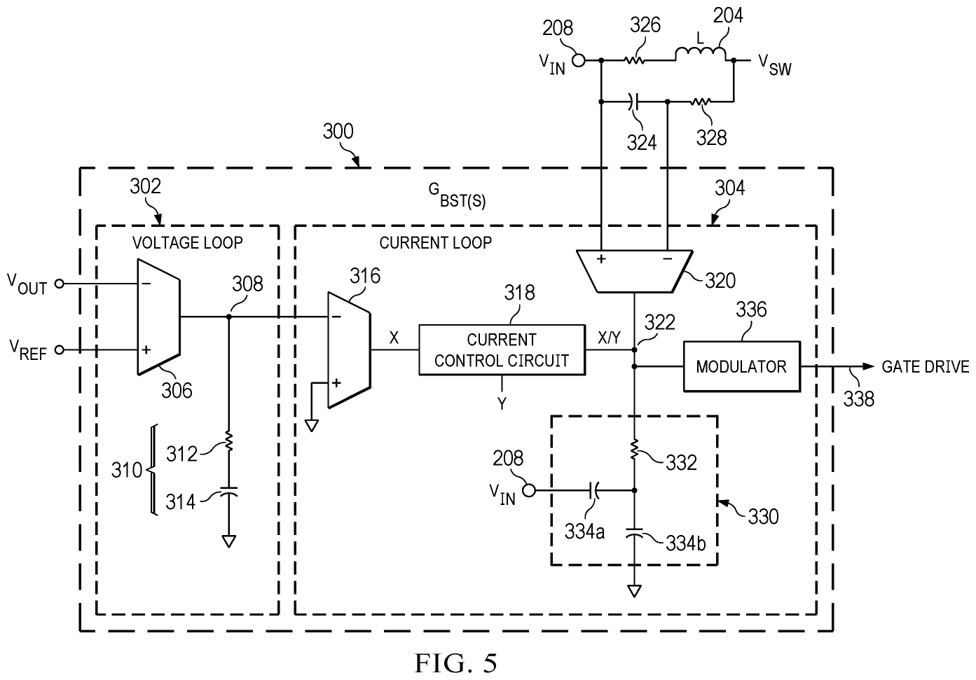

Referring to FIG. 5, there is illustrated another example of the control circuitry 300 in which the configuration of the resistive-capacitive filter 330 in the current control loop 304 is modified relative to the example illustrated in FIG. 3. In the example shown in FIG. 5, the resistive-capacitive filter 330 includes the resistor 332 and a pair of capacitors 334a, 334b. The first capacitor 334a is coupled between the input voltage terminal 208 and a junction between the resistor 332 and the second capacitor 334b. The resistor 332 and the second capacitor 334b are coupled in series between the output terminal 322 of the third transimpedance amplifier 320 and the reference terminal (e.g., ground). In some examples, a sum of the capacitance values of the first and second capacitors 334a, 334b is equal to the capacitance value of the capacitor 334 of FIG. 3.

As described above, the modulator 336 uses the adjusted control current, X/Y, provided at the output terminal 322 to produce the gate drive signal 338. In some examples, the modulator 336 produces a PWM square-wave signal for the gate drive signal 338 using a ramp signal that has a ramp height equal to the output voltage, Vout, divided by an adjustment, or modulation factor, M. In some examples, the modulation factor, M, is used to determine a ratio or proportion between the capacitance values of the first and second capacitors 334a, 334b. As described above, the sum of the capacitance values of the first and second capacitors 334a, 334b, equal to the total capacitance, C, of the resistive-capacitive filter 330, may be the same in the configurations of FIG. 3 and FIG. 5. In one example, the capacitance value, C1, of the first capacitor 334a is given by the total capacitance, C, divided by the modulation factor, M, (C1=C/M). The capacitance value, C2, of the second capacitor 334b is then given by the remainder of the total capacitance, C, (C2=C-C1). For example, if the modulation factor is 10, then the first capacitance value, C1, may be 0.1*C, and the second capacitance value, C2, may be 0.9*C. Using the configuration of the resistive-capacitive filter 330 shown in FIG. 5, with the capacitance values of the first and second capacitors 334a, 334b determined based on the modulation factor, M, as described above, may achieve further improvement in the PSRR of the power converter 200.

Thus, aspects and embodiments provide control circuitry for a DC-DC power converter in which the input voltage, Vin, is used as a feedforward signal introduced via the current control circuit 318, as described above. In this manner, the control signal for the DC-DC power converter can be automatically adjusted based on variations in the input voltage, Vin, without requiring any perturbation in the output voltage, Vout. As a result, the PSRR of the DC-DC converter can be improved. As described above, examples of the control circuitry automatically adjust both the duty cycle of the drive signals applied to the power transistors of the DC-DC converter and regulation of the inductor current, thus achieving PSRR improvement in boost and/or buck-boost DC-DC converter topologies.

### Further Examples

Example 1 is a control circuit comprising a voltage control loop configured to produce a control voltage based on an output voltage of a DC-DC converter and a reference voltage, and a current control loop configured to produce a control current based on the control voltage, and to adjust the control current based on a signal proportional to an input voltage of the DC-DC converter to provide an adjusted control current that is inversely proportional to the input voltage, and to produce, based on the adjusted control current and an inductor current in an inductor of the DC-DC converter, a drive signal to drive one or more power transistors of the DC-DC converter.

Example 2 includes the control circuit of Example 1, wherein the reference voltage is a first reference voltage, and the current control loop comprises a first transconductance amplifier coupled to the voltage control loop and configured to produce, at a current terminal, the control current based on the control voltage and a second reference voltage, a second transconductance amplifier configured to produce, at a sense terminal, a sense current based on the inductor current; and a current control circuit coupled to the first and second transconductance amplifiers and configured to adjust the control current to produce the adjusted control current.

Example 3 includes the control circuit of Example 2, wherein the current control circuit is configured to divide the control current by the signal proportional to the input voltage to produce the adjusted control current.

Example 4 includes the control circuit of one of Examples 2 or 3, wherein the current control circuit comprises a first transistor coupled between a voltage supply terminal and the current terminal of the first transconductance amplifier, a first current source coupled between the voltage supply terminal and a first control terminal of the first transistor, a second transistor coupled between the voltage supply terminal and a reference voltage terminal, a second current source coupled between the voltage supply terminal and a second control terminal of the second transistor, a third transistor coupled between the first current source and the reference voltage terminal and having a third control terminal coupled to the current terminal of the first transconductance amplifier, and a fourth transistor coupled between the second current source and the reference voltage terminal and having a fourth control terminal coupled to the current terminal of the first transconductance amplifier.

Example 5 includes the control circuit of Example 4, wherein the first current source produces a first current proportional to a third reference voltage, the third reference voltage corresponding to a maximum value of the input voltage; and wherein the second current source produces the signal proportional to the input voltage.

Example 6 includes the control circuit of one of Examples 4 or 5, wherein the current control circuit comprises a third current source coupled between the second transistor and the reference voltage terminal, and a fourth current source coupled between the current terminal of the first transconductance amplifier and the reference voltage terminal.

Example 7 includes the control circuit of any one of Examples 2-6, wherein the current control loop comprises a resistive-capacitive filter coupled between the sense terminal of the second transconductance amplifier and a reference voltage terminal, the resistive-capacitive filter having a resistance value and a filter capacitance value.

Example 8 include the control circuit of Example 7, wherein the current control loop comprises a voltage modulation circuit coupled to the sense terminal of the second transconductance amplifier and configured to modulate the drive signal using a ramp signal having a ramp height corresponding to the output voltage divided by a modulation factor, and wherein the resistive-capacitive filter includes a resistor having a first resistor terminal coupled to the sense terminal of the second transconductance amplifier and a second resistor terminal, the resistor having the resistance value, a first capacitor coupled between the second resistor terminal and the reference voltage terminal, and having a first capacitance value, and a second capacitor coupled between an input voltage terminal to receive the input voltage and the second resistor terminal, and having a second capacitance value, wherein the second capacitance value is equal to the filter capacitance value divided by the modulation factor, and wherein the first capacitance value is equal to the filter capacitance value minus the second capacitance value.

Example 9 includes the control circuit of any one of Examples 2-8, further comprising an input voltage terminal to receive the input voltage, an output voltage terminal to provide the output voltage, a first sense resistor coupled between the input voltage terminal and a first input terminal of the second transconductance amplifier, a second sense resistor coupled between the output voltage terminal and a second input terminal of the second transconductance amplifier, and a capacitor coupled between the first and second input terminals of the second transconductance amplifier.

Example 10 includes the control circuit of any one of Examples 1-9, wherein the voltage control loop comprises a transconductance amplifier having a first input terminal to receive the output voltage, a second input terminal to receive the reference voltage, and an output terminal to provide the control voltage, and a resistive-capacitive filter coupled in series between the output terminal of the transconductance amplifier and a reference voltage terminal.

Example 11 is a DC-DC power converter comprising the control circuit of any one of Examples 1-10, an input voltage terminal to receive the input voltage, an output voltage terminal to provide the output voltage, the one or more power transistors, and the inductor, wherein the inductor is coupled between the input voltage terminal and the output voltage terminal.

Example 12 includes the DC-DC power converter of Example 11, wherein the DC-DC power converter is one of a boost converter or a buck-boost converter.

Example 13 is a control circuit for a DC-DC power converter, the control circuit comprising a voltage control loop having a first input terminal, a second input terminal, and an output terminal, a first transconductance amplifier having a first input terminal coupled to the output terminal of the voltage control loop, a second input terminal coupled to a reference voltage terminal, and an output terminal, a second transconductance amplifier having a first and second input terminals and an output terminal, and a current control circuit having a current control input terminal and a current control output terminal, the current control input terminal coupled to the output terminal of the first transconductance amplifier, and the current control output terminal coupled to the output terminal of the second transconductance amplifier. The current control circuit comprises a first transistor coupled between a voltage supply terminal and the current control input terminal, a first current source coupled between the voltage supply terminal and a first control terminal of the first transistor, a second transistor coupled between the voltage supply terminal and the current control output terminal, a second current source coupled between the voltage supply terminal and a second control terminal of the second transistor, a third transistor coupled between the first current source and a ground terminal and having a third control terminal coupled to the current control input terminal, and a fourth transistor coupled between the second current source and the ground terminal and having a fourth control terminal coupled to the current control input terminal.

Example 14 includes the control circuit of Example 13, wherein the first current source is configured to produce a first current proportional to a reference voltage; and wherein the second current source is configured to produce a second current proportional to an input voltage of the DC-DC power converter.

Example 15 includes the control circuit of Example 14, wherein the reference voltage corresponds to a maximum value of the input voltage.

Example 16 includes the control circuit of one of Examples 13 or 14, further comprising a resistive-capacitive filter coupled between the output terminal of the second transconductance amplifier and the ground terminal.

Example 17 includes the control circuit of any one of Examples 13-16, further comprising a resistive-capacitive filter coupled between the output terminal of the voltage control loop and the ground terminal.

Example 18 includes the control circuit of any one of Examples 13-17, comprising first and second inductor terminals between which an inductor of the DC-DC power converter can be coupled, a first resistor coupled between the first inductor terminal and the first input terminal of the second transconductance amplifier, a second resistor coupled between the second inductor terminal and the second input terminal of the second transconductance amplifier, and a capacitor coupled between the first and second input terminals of the second transconductance amplifier.

Example 19 includes the control circuit of any one of Examples 13-18, further comprising a voltage modulation circuit coupled to the current control output terminal of the current control circuit and configured to modulate a current at the current control output terminal of the current control circuit, and a resistive-capacitive filter having a filter capacitance value and including a resistor having first and second resistor terminals, the first resistor terminal coupled to the current control output terminal of the current control circuit, a first capacitor coupled between an input voltage terminal of the DC-DC power converter and the second resistor terminal and having a first capacitance value, and a second capacitor coupled between the second resistor terminal and the ground terminal and having a second capacitance value equal to the filter capacitance value minus the first capacitance value.

Example 20 includes the control circuit of Example 19, wherein the voltage modulation circuit is configured to modulate the current at the current control output terminal of the current control circuit using a ramp signal having a ramp height corresponding to a voltage at the output terminal divided by a modulation factor, and wherein the second capacitance value is equal to the filter capacitance value divided by the modulation factor.

Example 21 is a control circuit, comprising a voltage control loop circuit having a first input terminal to receive an output voltage of a DC-DC power converter, a second input terminal to receive a reference voltage, and an output terminal, a first transconductance amplifier circuit having a first voltage terminal coupled to the output terminal of the voltage control loop circuit, a second voltage terminal coupled to a first reference voltage terminal, and a current terminal, a second transconductance amplifier circuit configured to monitor an inductor current in the DC-DC power converter and having an output terminal, and a current control circuit having a first terminal coupled to the current terminal of the first transconductance amplifier circuit and a second terminal coupled to the output terminal of the second transconductance amplifier circuit, wherein the current control circuit is configured to modify a control current produced by the first transconductance amplifier circuit based on a signal proportional to an input voltage of the DC-DC power converter so as to produce a drive signal that modifies the inductor current in response to changes in the input voltage.

Example 22 includes the control circuit of Example 20, wherein the current control circuit is configured to modify the control current produced by the first transconductance amplifier circuit based on the signal proportional to the input voltage of the DC-DC power converter so as to produce the drive signal that modifies the inductor current in response to changes in the input voltage without perturbing the output voltage.

Example 23 includes the control circuit of one of Examples 21 or 22, wherein the current control circuit comprises a first transistor coupled between a voltage supply terminal and the first terminal, a first current source coupled between the voltage supply terminal and a first control terminal of the first transistor, a second transistor coupled between the voltage supply terminal and a second current source, a third current source coupled between the voltage supply terminal and a second control terminal of the second transistor, the third current source configured to produce a current proportional to the input voltage, a third transistor coupled between the first current source and a reference terminal and having a third control terminal coupled to the first terminal, and a fourth transistor coupled between the third current source and the reference terminal and having a fourth control terminal coupled to the first terminal.

Example 24 includes the control circuit of Example 23, wherein the current control circuit comprises a fourth current source coupled between the first terminal and the reference terminal.

Example 25 is a DC-DC power converter comprising the control circuit of any one of Examples 21-24.

Example 26 includes the DC-DC power converter of Example 25, wherein the DC-DC power converter is one of a boost converter or a buck-boost converter.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, such as by an end user and/or a third party.

While the use of particular transistors is described herein, other transistors (or equivalent devices) may be used instead. For example, a p-channel field effect transistor (PFET) may be used in place of an n-channel field effect transistor (NFET) with little or no changes to the circuit. Furthermore, other types of transistors may be used (such as bipolar junction transistors (BJTs)). Furthermore, the devices may be implemented in/over a silicon substrate (Si), a silicon carbide substrate (SiC), a gallium nitride substrate (GaN) or a gallium arsenide substrate (GaAs). Moreover, reference to transistor features such as gate, source, or drain is not intended to exclude any suitable transistor technologies. For instance, features such as source, drain, and gate are typically used to refer to a FET, while emitter, collector, and base are typically used to refer to a BJT. Such features may be used interchangeably herein. For instance, reference to the gate of a transistor may refer to either the gate of a FET or the base of a BJT, and vice-versa. In some examples, a control terminal may refer to either the gate of a FET or the base of a BJT. Any other suitable transistor technologies can be used. Any such transistors can be used as a switch, with the gate or base or other comparable feature acting as a switch select input that can be driven to connect the source and drain (or the emitter and collector, as the case may be).

References herein to a field effect transistor (FET) being “ON” (or a switch being closed) means that the conduction channel of the FET is present, and drain current may flow through the FET. References herein to a FET being “OFF” (or a switch being open) means that the conduction channel is not present, and drain current does not flow through the FET. A FET that is OFF, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter.

Modifications are possible in the described examples, and other examples are possible within the scope of the claims.

What is claimed is:

1. A control circuit comprising:
a voltage control loop configured to produce a control voltage based on an output voltage of a DC-DC converter and a reference voltage; and
a current control loop configured to produce a control current based on the control voltage, and to adjust the control current based on a signal proportional to an input voltage of the DC-DC converter to provide an adjusted control current that is inversely proportional to the input voltage, and to produce, based on the adjusted control current and an inductor current in an inductor of the DC-DC converter, a drive signal to drive one or more power transistors of the DC-DC converter.

2. The control circuit of claim 1, wherein the reference voltage is a first reference voltage, and the current control loop comprises:
a first transconductance amplifier coupled to the voltage control loop and configured to produce, at a current terminal, the control current based on the control voltage and a second reference voltage;
a second transconductance amplifier configured to produce, at a sense terminal, a sense current based on the inductor current; and
a current control circuit coupled to the first and second transconductance amplifiers and configured to adjust the control current to produce the adjusted control current.

3. The control circuit of claim 2, wherein the current control circuit is configured to divide the control current by the signal proportional to the input voltage to produce the adjusted control current.

4. The control circuit of claim 2, wherein the current control circuit comprises:
a first transistor coupled between a voltage supply terminal and the current terminal of the first transconductance amplifier;
a first current source coupled between the voltage supply terminal and a first control terminal of the first transistor;
a second transistor coupled between the voltage supply terminal and a reference voltage terminal;
a second current source coupled between the voltage supply terminal and a second control terminal of the second transistor;
a third transistor coupled between the first current source and the reference voltage terminal and having a third control terminal coupled to the current terminal of the first transconductance amplifier; and
a fourth transistor coupled between the second current source and the reference voltage terminal and having a fourth control terminal coupled to the current terminal of the first transconductance amplifier.

5. The control circuit of claim 4, wherein the first current source produces a first current proportional to a third reference voltage, the third reference voltage corresponding to a maximum value of the input voltage; and wherein the second current source produces the signal proportional to the input voltage.

6. The control circuit of claim 4, wherein the current control circuit comprises:
a third current source coupled between the second transistor and the reference voltage terminal; and
a fourth current source coupled between the current terminal of the first transconductance amplifier and the reference voltage terminal.

7. The control circuit of claim 2, wherein the current control loop comprises:
a resistive-capacitive filter coupled between the sense terminal of the second transconductance amplifier and a reference voltage terminal, the resistive-capacitive filter having a resistance value and a filter capacitance value.

8. The control circuit of claim 7, wherein the current control loop comprises:
a voltage modulation circuit coupled to the sense terminal of the second transconductance amplifier and configured to modulate the drive signal using a ramp signal having a ramp height corresponding to the output voltage divided by a modulation factor; and
wherein the resistive-capacitive filter includes
a resistor having a first resistor terminal coupled to the sense terminal of the second transconductance amplifier and a second resistor terminal, the resistor having the resistance value,
a first capacitor coupled between the second resistor terminal and the reference voltage terminal, and having a first capacitance value, and
a second capacitor coupled between an input voltage terminal to receive the input voltage and the second resistor terminal, and having a second capacitance value, wherein the second capacitance value is equal to the filter capacitance value divided by the modulation factor, and wherein the first capacitance value is equal to the filter capacitance value minus the second capacitance value.

9. The control circuit of claim 2, further comprising:
an input voltage terminal to receive the input voltage;
an output voltage terminal to provide the output voltage;
a first sense resistor coupled between the input voltage terminal and a first input terminal of the second transconductance amplifier;
a second sense resistor coupled between the output voltage terminal and a second input terminal of the second transconductance amplifier; and
a capacitor coupled between the first and second input terminals of the second transconductance amplifier.

10. The control circuit of claim 1, wherein the voltage control loop comprises:
a transconductance amplifier having a first input terminal to receive the output voltage, a second input terminal to receive the reference voltage, and an output terminal to provide the control voltage; and
a resistive-capacitive filter coupled in series between the output terminal of the transconductance amplifier and a reference voltage terminal.

11. A DC-DC power converter comprising:
the control circuit of claim 1;
an input voltage terminal to receive the input voltage;
an output voltage terminal to provide the output voltage;
the one or more power transistors; and
the inductor, wherein the inductor is coupled between the input voltage terminal and the output voltage terminal.

12. The DC-DC power converter of claim 11, wherein the DC-DC power converter is one of a boost converter or a buck-boost converter.

13. A control circuit for a DC-DC power converter, the control circuit comprising:
a voltage control loop having a first input terminal, a second input terminal, and an output terminal;
a first transconductance amplifier having a first input terminal coupled to the output terminal of the voltage control loop, a second input terminal coupled to a reference voltage terminal, and an output terminal;
a second transconductance amplifier having a first and second input terminals and an output terminal; and
a current control circuit having a current control input terminal and a current control output terminal, the current control input terminal coupled to the output terminal of the first transconductance amplifier, and the current control output terminal coupled to the output terminal of the second transconductance amplifier, wherein the current control circuit comprises
a first transistor coupled between a voltage supply terminal and the current control input terminal,
a first current source coupled between the voltage supply terminal and a first control terminal of the first transistor,
a second transistor coupled between the voltage supply terminal and the current control output terminal,
a second current source coupled between the voltage supply terminal and a second control terminal of the second transistor,
a third transistor coupled between the first current source and a ground terminal and having a third control terminal coupled to the current control input terminal, and
a fourth transistor coupled between the second current source and the ground terminal and having a fourth control terminal coupled to the current control input terminal.

14. The control circuit of claim 13, wherein the first current source is configured to produce a first current proportional to a reference voltage; and wherein the second current source is configured to produce a second current proportional to an input voltage of the DC-DC power converter.

15. The control circuit of claim 14, wherein the reference voltage corresponds to a maximum value of the input voltage.

16. The control circuit of claim 13, further comprising a resistive-capacitive filter coupled between the output terminal of the second transconductance amplifier and the ground terminal.

17. The control circuit of claim 13, further comprising a resistive-capacitive filter coupled between the output terminal of the voltage control loop and the ground terminal.

18. The control circuit of claim 13, comprising:
first and second inductor terminals between which an inductor of the DC-DC power converter can be coupled;
a first resistor coupled between the first inductor terminal and the first input terminal of the second transconductance amplifier;
a second resistor coupled between the second inductor terminal and the second input terminal of the second transconductance amplifier; and
a capacitor coupled between the first and second input terminals of the second transconductance amplifier.

19. The control circuit of claim 13, further comprising:
a voltage modulation circuit coupled to the current control output terminal of the current control circuit and configured to modulate a current at the current control output terminal of the current control circuit; and
a resistive-capacitive filter having a filter capacitance value and including
a resistor having first and second resistor terminals, the first resistor terminal coupled to the current control output terminal of the current control circuit,
a first capacitor coupled between an input voltage terminal of the DC-DC power converter and the second resistor terminal and having a first capacitance value, and
a second capacitor coupled between the second resistor terminal and the ground terminal and having a second capacitance value equal to the filter capacitance value minus the first capacitance value.

20. A control circuit, comprising:
a voltage control loop circuit having a first input terminal to receive an output voltage of a DC-DC power converter, a second input terminal to receive a reference voltage, and an output terminal;
a first transconductance amplifier circuit having a first voltage terminal coupled to the output terminal of the voltage control loop circuit, a second voltage terminal coupled to a first reference voltage terminal, and a current terminal;
a second transconductance amplifier circuit configured to monitor an inductor current in the DC-DC power converter and having an output terminal; and
a current control circuit having a first terminal coupled to the current terminal of the first transconductance amplifier circuit and a second terminal coupled to the output terminal of the second transconductance amplifier circuit, wherein the current control circuit is configured to modify a control current produced by the first transconductance amplifier circuit based on a signal proportional to an input voltage of the DC-DC power converter so as to produce a drive signal that modifies the inductor current in response to changes in the input voltage.

21. The control circuit of claim 20, wherein the current control circuit is configured to modify the control current produced by the first transconductance amplifier circuit based on the signal proportional to the input voltage of the DC-DC power converter so as to produce the drive signal that modifies the inductor current in response to changes in the input voltage without perturbing the output voltage.

22. The control circuit of claim 20, wherein the current control circuit comprises:
a first transistor coupled between a voltage supply terminal and the first terminal;
a first current source coupled between the voltage supply terminal and a first control terminal of the first transistor;
a second transistor coupled between the voltage supply terminal and a second current source;
a third current source coupled between the voltage supply terminal and a second control terminal of the second transistor, the third current source configured to produce a current proportional to the input voltage;
a third transistor coupled between the first current source and a reference terminal and having a third control terminal coupled to the first terminal; and
a fourth transistor coupled between the third current source and the reference terminal and having a fourth control terminal coupled to the first terminal.

23. The control circuit of claim 22, wherein the current control circuit comprises:
a fourth current source coupled between the first terminal and the reference terminal.

24. A DC-DC power converter comprising the control circuit of claim 20.

25. The DC-DC power converter of claim 24, wherein the DC-DC power converter is one of a boost converter or a buck-boost converter.
